(19) United States
(12) Patent Application Publication
(10) Pub. No.: US 2025/0114257 A1
(43) Pub. Date: Apr. 10, 2025

(54) Powered Wheelchair For Vocational Activities

(71) Applicants: United States Government As Represented By The Department Of Veterans Affairs, Washington, DC (US); University Of Pittsburgh - Of The Commonwealth System Of Higher Education, Pittsburgh, PA (US)

(72) Inventors: Rory A. Cooper, Pittsburgh, PA (US); Jorge Luis Candiotti, Pittsburgh, PA (US); Garrett G. Grindle, Pittsburgh, PA (US); Benjamin T. Gebrosky, Pittsburgh, PA (US); Joshua David Kanode, Pittsburgh, PA (US); Keshav Mukherjee, Pittsburgh, PA (US)

(21) Appl. No.: 18/909,078

(22) Filed: Oct. 8, 2024

Related U.S. Application Data
(60) Provisional application No. 63/588,883, filed on Oct. 9, 2023.

(51) Int. Cl. A61G 5/10; A61G 5/04

(52) U.S. Cl. CPC A61G 5/1059; A61G 5/04

(57) ABSTRACT

A wheelchair comprising a base assembly including a body portion having a frame and a plurality of wheel assemblies secured to the body portion. A seat assembly including a frame with a seating portion is supported on the base assembly, and a vertical lift assembly is secured to the base assembly and extends vertically upward therefrom. The vertical lift assembly is configured to move the seat assembly about and between a lowered vertical position and a raised vertical position. The lowered vertical position and the raised vertical position can be separated by at least 24.0 inches.

### CROSS-REFERENCE TO RELATED APPLICATIONS

This application claims priority to and the benefit of the filing date of U.S. Provisional Patent Application No. 63/588,883, filed Oct. 9, 2023, the entirety of which is hereby incorporated by reference herein.

### STATEMENT OF GOVERNMENT SUPPORT

This invention was made with government support through grant number EEC-1852322 of the National Science Foundation, and grant numbers B2988C, B9269L, and A3076M of the U.S. Department of Veterans Affairs. The government has certain rights in the invention.

### FIELD

This application relates to personal mobility devices and, in particular, to wheelchairs for use in vocational settings.

### BACKGROUND

Wheeled power mobility is needed to allow individuals with mobility impairments to perform daily activities at home, work, and participate in the community. The ability to negotiate indoor and outdoor environments is important to achieving effective functional mobility. Unfortunately, wheelchairs require an additional number of turns and maneuvers to smoothly navigate environmental barriers in a safe and comfortable manner. In addition to the need to maneuver efficiently, a wheelchair should also be able to elevate to heights not reachable in traditional personal mobility devices.

In recent years the advent of the powered electric wheelchair has revolutionized life for many individuals who struggle to maintain their sense of independence given their physical disabilities. As noted above, there exists a need for wheelchairs that are tailored to vocational settings such as, but not limited to, warehouse jobs, which often require higher degrees of mobility than traditional environments. For example, vertical mobility to pick up tools from the ground or high shelves and efficient movement within tight confined spaces and across the workspace are often required in warehouse activities. Despite technological advancements for at-home wheelchairs, there remains a need for powered wheelchairs designed specifically for vocational settings.

### SUMMARY

Disclosed herein, in one aspect, is a wheelchair comprising a base assembly including a body portion having a frame and a plurality of wheel assemblies secured to the body portion. A seat assembly including a frame with a seating portion is supported on the base assembly, and a vertical lift assembly is secured to the base assembly and extends vertically upward therefrom. The vertical lift assembly is configured to move the seat assembly about and between a lowered vertical position and a raised vertical position. The lowered vertical position and the raised vertical position can be separated by at least 24.0 inches. This vertical displacement allows a user to achieve heights that were previously inaccessible to persons in wheelchairs.

In yet another embodiment, a wheelchair may include a base assembly having a body portion with a frame and a plurality of wheel assemblies secured to the body portion. A seat assembly includes a frame with a seating portion supported thereon, and a vertical lift assembly includes a linear actuator having a lead screw operably secured to the base assembly and extending vertically upwardly therefrom. A cam assembly is secured to the seat assembly and travels linearly along the lead screw as the lead screw is rotated, so that the seat assembly is movable about and between a lowered vertical position, adjacent the base, and a raised vertical position, adjacent to the top end of the vertical lift assembly. Embodiments of the disclosed wheelchairs are intended to facilitate movement, both laterally and vertically, of those individuals in need of assistance, thereby improving quality of life.

Yet other embodiments may provide a wheelchair having a wheelbase featuring a delta arrangement of wheels that work in coordination with each other to achieve high degrees of maneuverability. To meet the vertical range of motion requirements, a lead-screw-based linear actuator vertical left assembly may be provided on the wheelbase and allow the user to travel comfortably to varying heights.

Additional advantages of the disclosed system and method will be set forth in part in the description that follows, and in part will be understood from the description, or may be learned by practice of the disclosed system and method. The advantages of the disclosed system and method will be realized and attained by means of the elements and combinations particularly pointed out in the appended claims. It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate several embodiments of the disclosed apparatus, system, and method and together with the description, serve to explain the principles of the disclosed apparatus, system, and method.

FIG. 1 is a perspective view of a wheelchair in accordance with an exemplary embodiment of the disclosure.

FIG. 2 shows a top plan view of the wheelchair shown in FIG. 1.

FIG. 3A shows a side elevational view of the wheelchair shown in FIG. 1 with the seat assembly in the lowered position, and FIG. 3B shows a side elevational view of the wheelchair shown in FIG. 1 with the seat assembly in the raised position.

FIG. 4A shows a front elevational view of the wheelchair shown in FIG. 1 with the seat assembly in the lowered position, and FIG. 4B shows a front elevational view the wheelchair shown in FIG. 1 with the seat assembly in the raised position.

FIG. 5A shows a perspective exploded view of the vertical lift assembly of the wheelchair shown in FIG. 1, and FIG. 5B shows an exploded side view of the vertical lift assembly of the wheelchair shown in FIG. 1.

FIG. 6 shows an exploded top plan view of the base assembly of the wheelchair shown in FIG. 1.

FIG. 7 shows a side view of another exemplary wheelchair in accordance with the present disclosure.

FIG. 8A shows an exploded perspective view of a wheel assembly of the wheelchair of FIG. 7, and FIG. 8B shows an exploded side view of the wheelchair of FIG. 7.

FIG. 9 shows an exploded view of a base assembly in accordance with embodiments disclosed herein.

FIG. 10 shows an exploded view of a vertical lift assembly of the wheelchair shown in FIG. 7.

FIG. 11 shows a perspective view of an exemplary interface for the wheelchair shown in FIG. 7, including a joystick and a pair of toggle buttons.

### DETAILED DESCRIPTION

The disclosed system and method may be understood more readily by reference to the following detailed description of particular embodiments and the examples included therein and to the Figures and their previous and following description.

It is to be understood that the terminology used herein is for the purpose of describing particular embodiments only and is not intended to limit the scope of the present invention which will be limited only by the appended claims.

It must be noted that as used herein and in the appended claims, the singular forms “a,” “an,” and “the” can optionally include plural references unless the context clearly dictates otherwise. Thus, for example, reference to a “wheel assembly” can represent a disclosure of embodiments in which only a single wheel assembly is provided, as well as a disclosure of embodiments in which a plurality of wheel assemblies are provided.

“Optional” or “optionally” means that the subsequently described event, circumstance, or material may or may not occur or be present, and that the description includes instances where the event, circumstance, or material occurs or is present and instances where it does not occur or is not present.

Ranges may be expressed herein as from “about” one particular value, and/or to “about” another particular value. When such a range is expressed, also specifically contemplated and considered disclosed is the range from the one particular value and/or to the other particular value unless the context specifically indicates otherwise. Similarly, when values are expressed as approximations, by use of the antecedent “about,” it will be understood that the particular value forms another, specifically contemplated embodiment that should be considered disclosed unless the context specifically indicates otherwise. It will be further understood that the endpoints of each of the ranges are significant both in relation to the other endpoint, and independently of the other endpoint unless the context specifically indicates otherwise. Finally, it should be understood that all of the individual values and sub-ranges of values contained within an explicitly disclosed range are also specifically contemplated and should be considered disclosed unless the context specifically indicates otherwise. The foregoing applies regardless of whether in particular cases some or all of these embodiments are explicitly disclosed.

Optionally, in some aspects, when values or characteristics are approximated by use of the antecedents “about,” “substantially,” or “generally,” it is contemplated that values within up to 15%, up to 10%, up to 5%, or up to 1% (above or below) of the particularly stated value or characteristic can be included within the scope of those aspects.

Unless defined otherwise, all technical and scientific terms used herein have the same meanings as commonly understood by one of skill in the art to which the disclosed apparatus, system, and method belong. Although any apparatus, systems, and methods and materials similar or equivalent to those described herein can be used in the practice or testing of the present apparatus, system, and method, the particularly useful methods, devices, systems, and materials are as described.

Throughout the description and claims of this specification, the word “comprise” and variations of the word, such as “comprising” and “comprises,” means “including but not limited to,” and is not intended to exclude, for example, other additives, components, integers or steps. In particular, in methods stated as comprising one or more steps or operations it is specifically contemplated that each step comprises what is listed (unless that step includes a limiting term such as “consisting of”), meaning that each step is not intended to exclude, for example, other additives, components, integers or steps that are not listed in the step.

As used herein, the term “caster” should be understood to include both conventional casters (e.g., wheels that swivel about an axis that is perpendicular to their axis of rotation) as well as omni-wheels, which include rollers that permit movement perpendicular or substantially perpendicular (e.g., within 10 degrees or within 5 degrees of perpendicular) to the axis of rotation of the wheel.

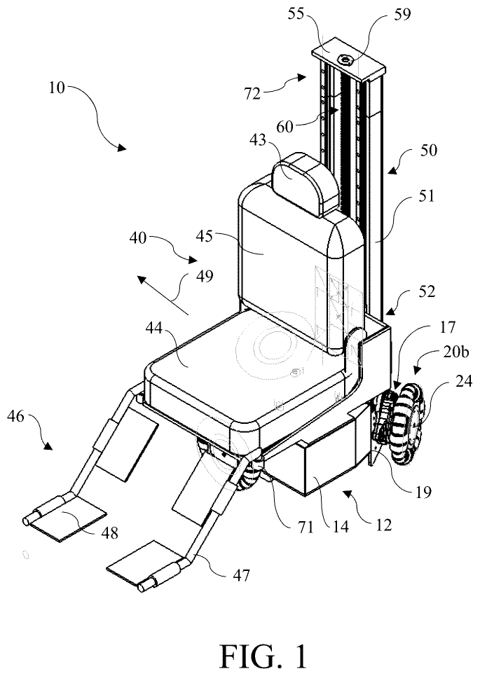

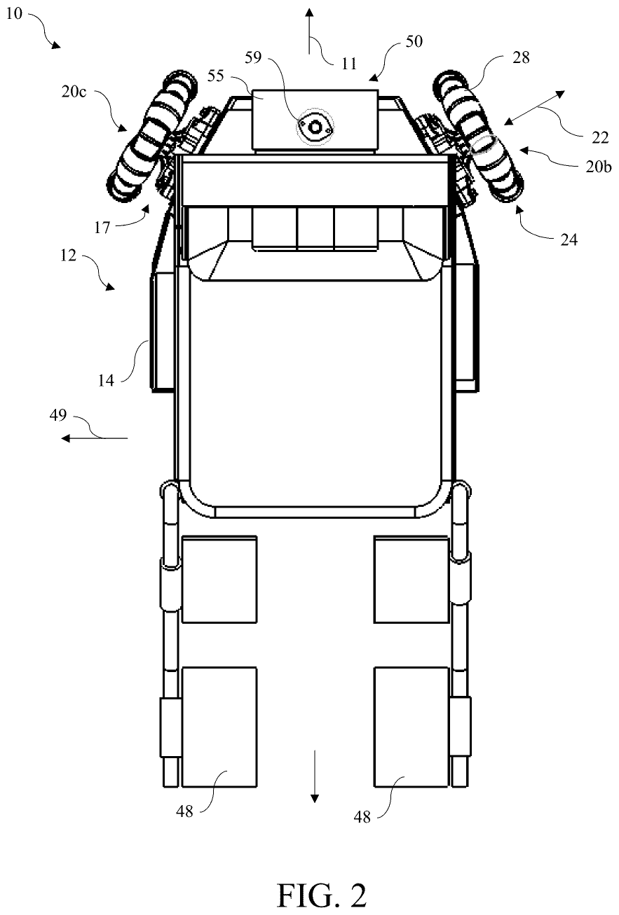

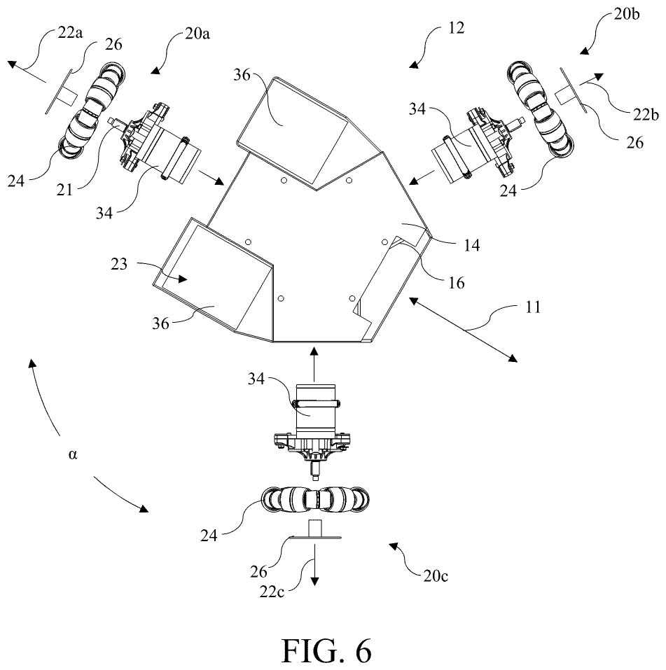

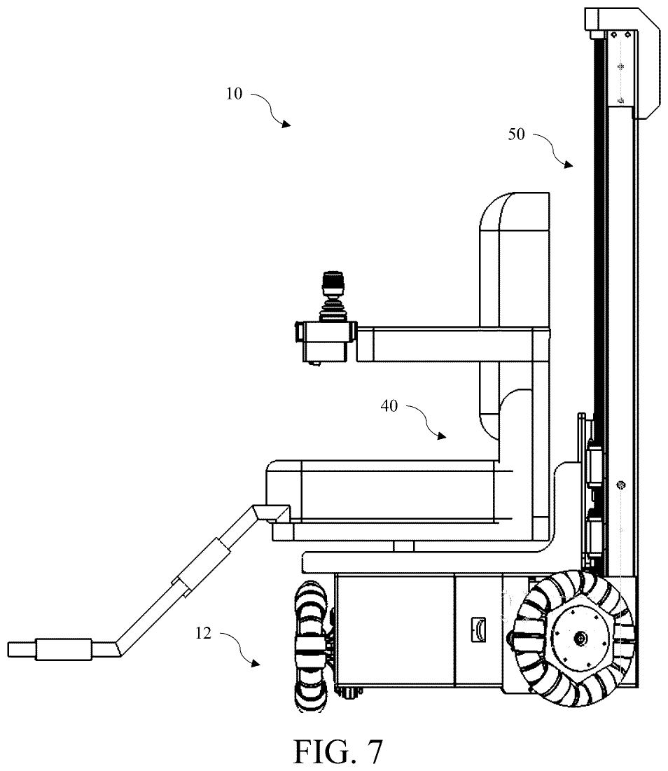

Referring now to the Figures, an embodiment of a powered wheelchair 10 for use in vocational activities in accordance with the disclosure is shown. As seen in FIGS. 1 and 2, the wheelchair 10 includes a base assembly 12, a seat assembly 40 that is secured to the base assembly 12 by a vertical lift assembly 50, and a plurality of wheel assemblies 20 secured to the base assembly 12. Referring additionally to FIG. 6, the base assembly 12 includes a body portion 14 that is strengthened by a frame 16. The body portion 14 includes a top plate 13 and a bottom plate 15 that are parallel or substantially parallel (e.g., within 10 degrees or within 5 degrees of parallel) to each other and secured to each other by a plurality of vertical walls 19. In the embodiment shown, three wheel recesses 17 are formed on the body portion 14 so that each of the three wheel assemblies 20 is independently mountable to the base assembly 12. Each wheel recess 17 is configured to receive a driving motor 34 of a corresponding wheel assembly 20. In some aspects, the driving motor 34 can include an integral gear box 35. In additional aspects, a gearbox 35 can be coupled to the driving motor 34. The plurality of wheel assemblies 20 is coupled to the body portion 14 so that the plurality of wheel assemblies 20 distributes the weight of the wheelchair to a support surface underneath (e.g., the floor or the ground). As shown, each wheel assembly includes a wheel 24 centered around a hub 26 that is rotatably supported on a powered axle 21. Additionally, the body portion 14 defines a pair of battery compartments 23, each battery compartment 23 being configured to removably receive a battery 36 that provides power to the electric wheelchair 10. For example, LiFePO₄ rechargeable batteries 36 can be used in the exemplary embodiments, although alternate types of batteries can be used.

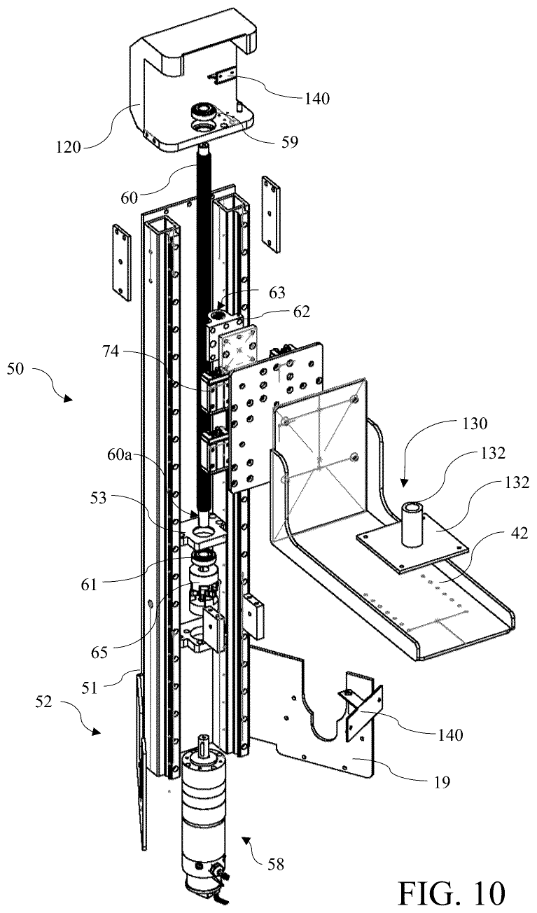

As shown, the seat assembly 40 can have a frame 42 to which a seating portion 44, a back support portion 45, and a headrest 43 are mounted. Additionally, a pair of leg supports 46 can be secured to a front portion of the frame 42 of the seat assembly. Each leg support 46 can include an elongated frame member 47 and one or more platforms 48 for supporting the lower leg and foot of the user. In some aspects, to allow the seat assembly 40 to be lowered to the greatest extent possible, each leg support 46 may be secured at its proximal end to the frame 42 of the seat assembly by a pivoting bracket 71. In some aspects, the pivoting bracket 71 can prevent contact of the leg supports 46 with the support surface from limiting downward motion. Referring to FIG. 10, in some aspects, the seat 44 can be coupled to the frame 42 of the seat assembly 40 by a seat mount 130. The seat mount 130 can be coupled to the frame 42 of the seat assembly 40 at a selected distance from the vertical lift assembly 50 to select a location of the center of mass when a user is seated in the seat. In some aspects, the seat mount 130 can comprise a base 132 and a tubular support socket 134 extending from the base.

Still referring to FIG. 6, an embodiment of the wheelchair 10 includes a front wheel assembly 20a and two rear wheel assemblies 20b and 20c. More generally, the wheelchair can comprise any suitable number of wheel assemblies, such as, for example, four wheel assemblies. As shown, each wheel assembly 20a, 20b, and 20c includes a longitudinal center axis 22 about which its corresponding wheel 24 rotates. In some aspects, the longitudinal center axis 22 of the front wheel assembly can form an angle with the longitudinal center axis 22 of one of the rear wheel assemblies that is less than 180°. In exemplary non-limiting aspects, each longitudinal center axis 22 may be separated by an angle a of approximately 120 degrees from the longitudinal center axes 22 of the adjacent wheel assemblies 20. However, it is contemplated that other angular orientations may be used. For example, at least two longitudinal center axes 22 can be separated by an angle a from 80° to 180°, or from 105° to 165°. As an example, the longitudinal center axis 22a of the front wheel assembly 20a lies along the longitudinal (fore and aft) axis 11 of the wheelchair 10. As such, the longitudinal center axes 22b and 22c of the rear wheel assemblies 20b and 20c, respectively, both lie in a plane such that their longitudinal center axes 22b and 22c are disposed at a selected acute angle (e.g., from 40° to 80° or at about 60°) on either side of the longitudinal axis 11 of the wheelchair 10.

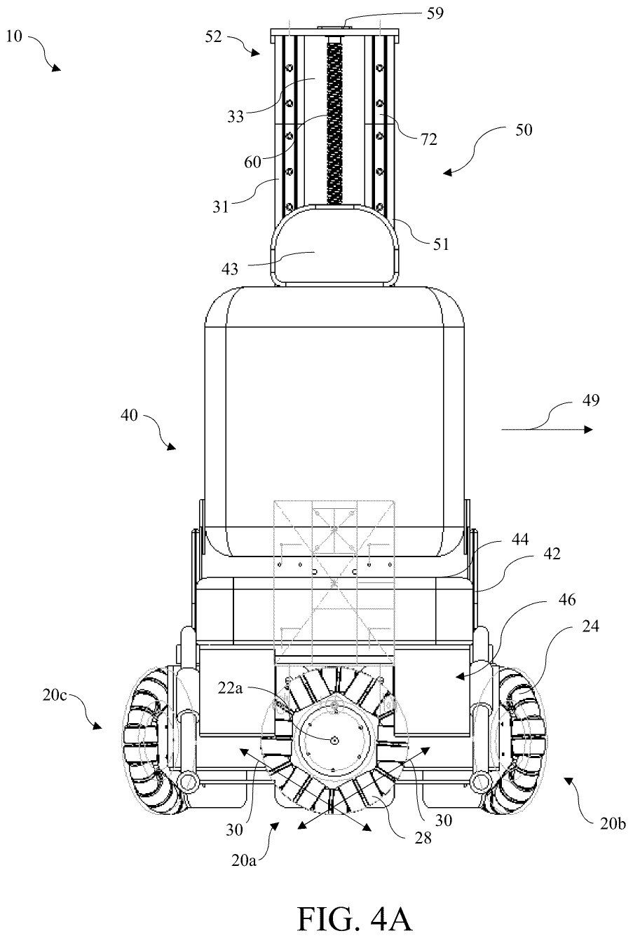

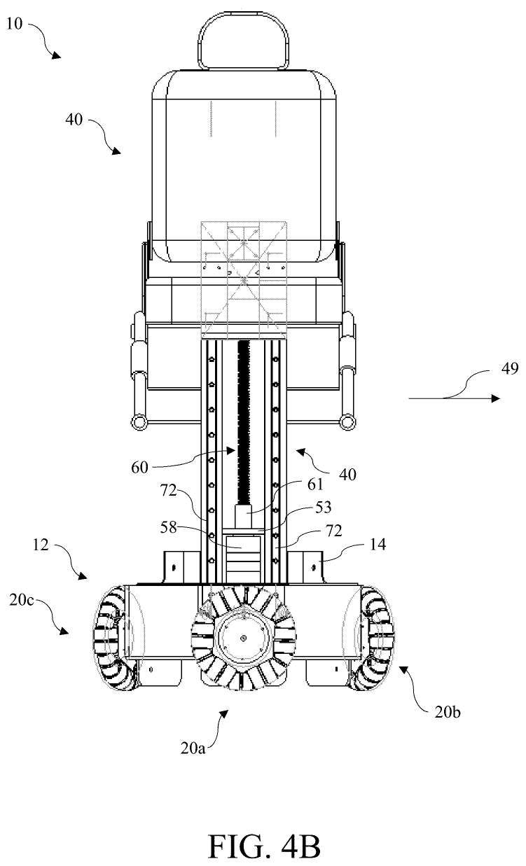

Disposed about the periphery of the wheel 24a, 24b, and 24c of each wheel assembly 20a, 20b, and 20c are a plurality of rollers 28. For example, as best seen in FIG. 4A, disposed about the periphery of the front wheel 24a are rollers 28. Each of the other wheels 24b and 24c includes similar rollers. The axes of rotation 30 of the rollers 28 correspond to chords of the circumference of the wheels 24a, 24b, and 24c. The rollers 28 enable the omnidirectional base to move in directions other than the axis of rotation of the wheels 24a, 24b, and 24c. For example, if the base assembly 12 shown in FIG. 6 is to move directly forward or backward along longitudinal axis 11, the motor gearbox 34 of the front wheel assembly 20a will not drive front wheel 24a, while the corresponding motor gearboxes 34 for each of the rear wheels 24b and 24c will drive those wheels at an equal speed in the same direction. As shown, the left-side wheel 24b is rotated in the counter-clockwise (CC) direction as the right-side wheel 24c is driven in the clockwise (CW) direction to move the wheelchair 10 in the forward direction. In this manner, front wheel 24a can roll along the ground (or other underlying surface) in the direction of its axis of rotation 22a by virtue of the rotation of the rollers 28 around its periphery.

With reference to FIGS. 4A-4B, if the wheelchair 10 is to be driven to the right-hand side in the direction of arrow 49 (from the perspective of the wheelchair user), each of wheels 24b and 24c of the rear wheel assemblies 20 and 20 can be driven in the clockwise (CW) direction (as viewed from the exterior side of the wheel), while wheel 24a of the front wheel assembly 20a can be driven in the counterclockwise (CCW) direction. By driving wheels 24b and 24c at an angular rate sufficient to make the component of their rotation in the direction of arrow 49 equal to the angular rotation of wheel 24a, the base will move in the direction of arrow 49. In a like manner, by driving each wheel at the appropriate angular rotation rate, the omnidirectional base can be moved in any direction.

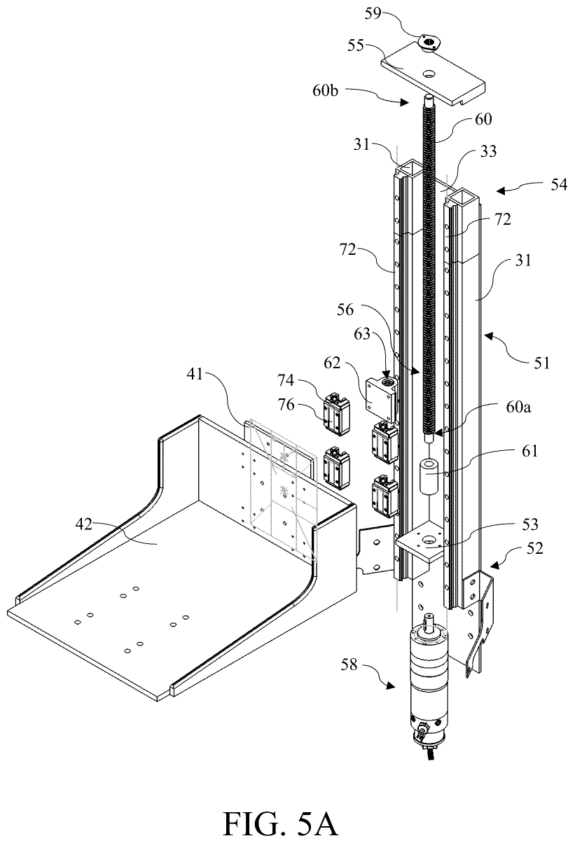

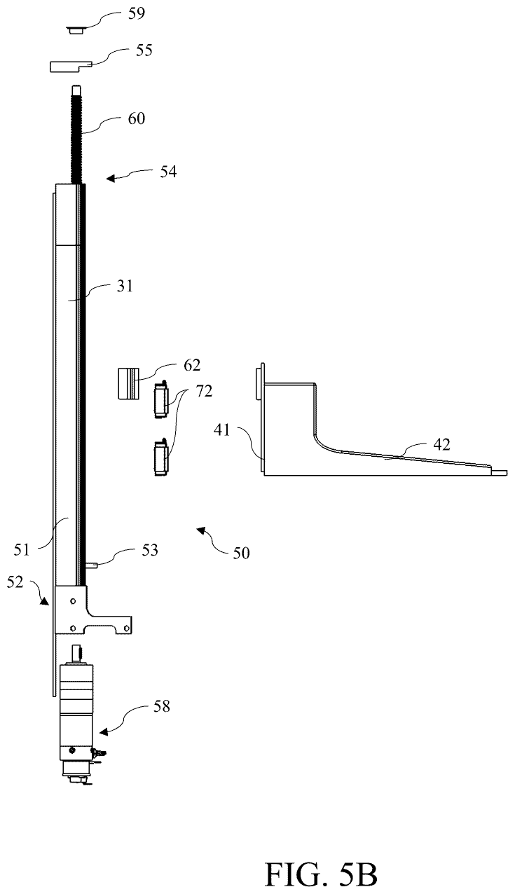

Referring now to FIGS. 5A and 5B, the vertical lift assembly 50 of an embodiment of the wheelchair 10 can include an elongated housing 51 that is secured to the body portion 14 (FIG. 1) of the base assembly 12 (FIG. 1) at its bottom end 52. In some aspects, at least a portion of the base assembly 12 can be welded to the vertical lift assembly 50. For example, at least a portion of a vertical wall 19 can be welded to the elongated housing 51 of the vertical lift assembly 50. The housing 51 is substantially U-shaped in cross-section and formed by a pair of parallel or substantially parallel elongated tubes 31 that are connected by a wall 33 that extends therebetween. The vertical lift assembly 50 can further comprise linear actuator assembly 56 at least partially housed within the housing 51. The vertical lift assembly 50 can include a lead screw 60 having a bottom end 60a that is rotatably supported in a bottom plate 53 disposed at the bottom end 52 of the housing 51, and a top end 60b that is rotatably secured to a top plate 55 disposed at the top end 54 of the housing 51. As best seen in FIG. 5A, the bottom end 60a and the top end 60b of the lead screw 60 are rotatably supported by the bottom plate 53 and an upper bearing 59 in the top plate 55. In further aspects, and with reference to FIG. 10, the bottom end 60a of the lead screw 60 can be rotatably supported by a lower bearing 61. Referring to FIG. 10, the vertical lift assembly 50 can further comprise a top enclosure 120 that is configured to cover the upper bearing 59. In some aspects, the top enclosure 120 can support the upper bearing 59 instead of providing a separate upper plate. A coupling 65 can couple the motor assembly 58 to the lead screw 60. A motor assembly 58 is secured to the bottom end 52 of the vertical lift assembly 50 and is at least partially housed within the body portion 14 of the base assembly. In some aspects, the motor assembly 58 can be a DC motor capable of 240 revolutions per minute and can be powered by the batteries 36, as are the motors 34 of the wheel assemblies 20a, 20b, 20c. In some optional aspects, the pitch of the thread of the linear screw can be one quarter inch (¼ in.), meaning the lead screw 60 is capable of driving the seat assembly 40 in the up or down direction a distance of an inch per second. Note, alternate embodiments may include a lead screw having a different thread pitch, as well as a drive motor assembly 58 capable of higher revolutions per minute (RPM), meaning the rate at which the seat assembly 40 can be raised and lowered can vary.

Still referring to FIGS. 5A and 5B, the vertical lift assembly 50 can include at least one rail. For example, in some aspects, the vertical lift assembly 50 can comprise a pair of linear slide rail bearings 70 configured to guide the motion of the seat assembly 40. Each linear slide rail bearing 70 includes an elongated rail 72 and at least one bearing block 74 (e.g., a pair of bearing blocks 74) that is configured to slide along the elongated rail. Each rail 72 is secured along the length of a corresponding tube 31 of the housing 51 of the vertical lift assembly 50. Each bearing block 74 defines a groove 76 therein that slidably receives a portion of the corresponding rail 72 therein so that the bearing block 74 is both retained in the rail 72 and slidable along the rail 72. Each bearing block 74 is secured to a mounting plate 41 that is in turn secured to the back wall of the frame 42 of the seat assembly 40. As best seen in FIGS. 5A and 5B, a cam structure or a cam assembly 62 is also mounted to the mounting plate 41 on the back wall of the seat assembly 40. In the instant case, the cam assembly 62 is a ball screw nut 62 that defines a bore 63 therethrough. The bore 63 of the ball screw nut 62 is configured to rotatably receive the lead screw 60 of the linear actuator assembly 50 therein. In additional aspects, the wheelchair 10 can comprise a cam structure, such as a nut or a toothed gear that is configured to engage the thread(s) of the lead screw so that rotation of the lead screw effects axial movement of the cam structure.

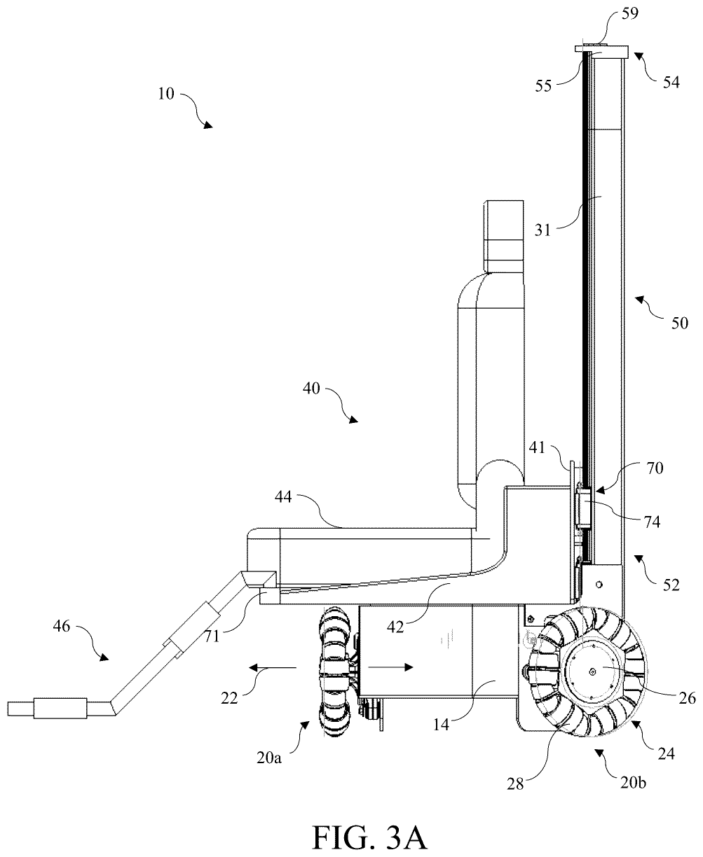

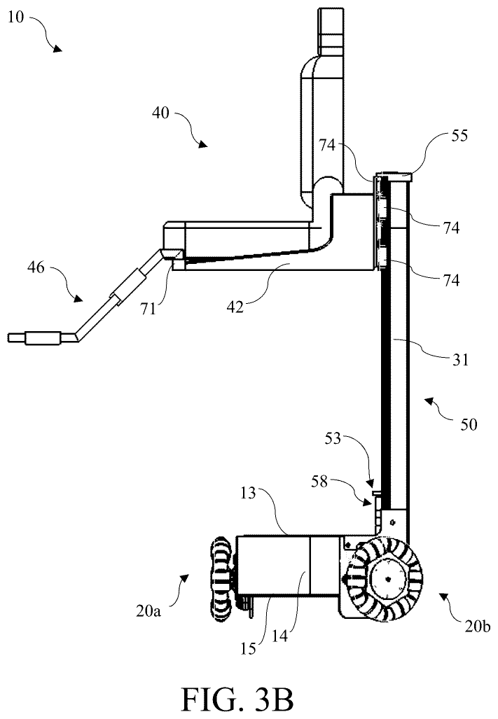

As best seen in FIGS. 3A and 4A, the seat assembly 40 of the wheelchair 10 is shown in the bottom-most position in which a user may be able to reach items, such as tools, dropped on the support surface below the wheelchair 10. Rotation of the lead screw 60 in a first direction by the motor assembly 58 causes the ball screw nut 62 and, therefore, seat assembly 40 to move upwardly along the length of the lead screw 60. The linear slide rail bearings 70 ensure that stresses are distributed evenly from the frame 42 of the seat assembly 40 to the housing 51 of the vertical lift assembly 50 and promote smooth motion of the seat assembly 40 along the rails 72 of the vertical lift assembly 50. Referring now to FIGS. 3B and 4B, the seat assembly 40 is shown at the upper extent of its travel along the lead screw 60 of the vertical lift assembly 50. In some aspects, the vertical lift assembly 50 can be configured to move the seat assembly 40 about and between a lowered vertical position and a raised vertical position. That is, the vertical lift assembly 50 can be configured to move the seat assembly 24 to a user-selected height between and including the lowered vertical position to the raised vertical position. In some aspects, the lowered vertical position to the raised vertical position can be spaced by at least 24 inches, or at least 36 inches in the vertical direction. However, in alternate embodiments the range of motion of the seat assembly 40 may be greater than 36 inches. Notably, the stability provided by the base assembly 12 and associated wheel assemblies 20 allows the wheelchair to move about the support surface while the seat assembly 40 is in the fully raised position (FIGS. 3B and 4B).

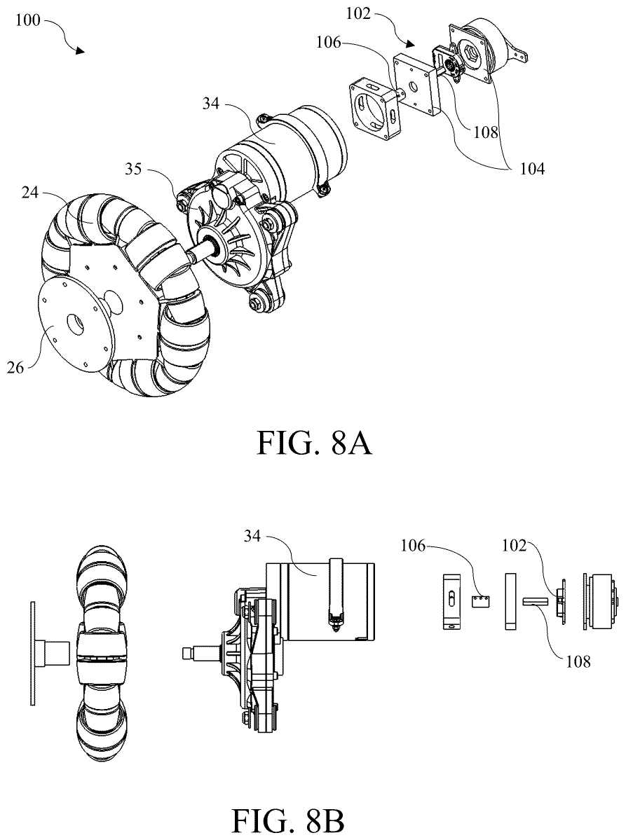

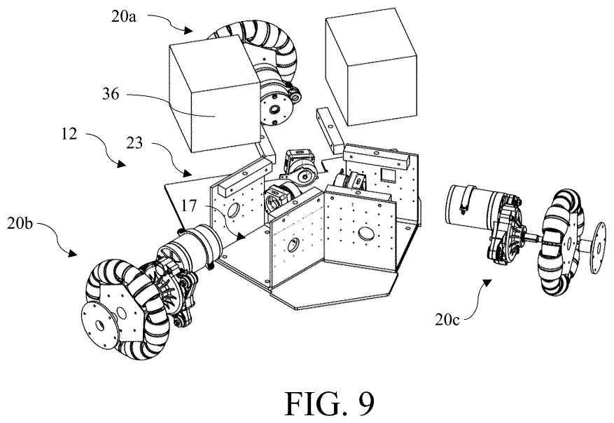

Referring to FIG. 8, in some aspects, the wheelchair 10 can comprise an encoder assembly 100 in communication with each of the driving motors 34. The encoder assembly 100 can be used to monitor driving metrics. The encoder assembly 100 can include an encoder 102. Optionally, the encoder 102 can be an incremental quadrature encoder. In this way, the encoder can determine direction of rotation. The encoder 102 can be housed within an encoder housing 104. The encoder assembly 100 can further comprise a coupler 106 and a shaft extension 108. The coupler 106 and the shaft extension 108 can provide an extension of the shaft between the motor's gear system and motor's brake. The encoder 102 can connected to the shaft extension 108 to measure the motor revolutions of the motor. The measured motor revolutions of each of the motors can be translated into position and speed of the wheelchair 10.

Referring to FIG. 10, in some aspects, limit switches (not shown) can be coupled to mounting supports 140. Feedback from the limit switches can limit a vertical position of the seat. For example, upon triggering (e.g., contact with) the limit switches, further rotation of the motor 34 to raise or lower the seat can be inhibited.

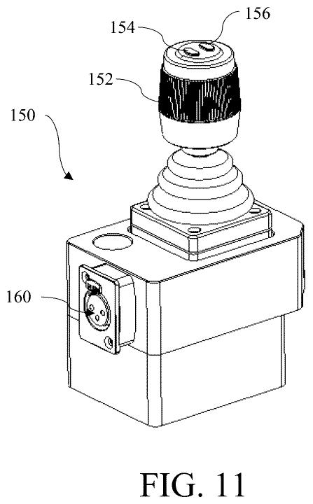

Referring to FIG. 11, the wheelchair can comprise a user interface module 150 that permits the user to operate the wheelchair. In some aspects, the user interface module 150 can be configured for use with individuals having low levels of hand dexterity. In other aspects, the user interface module 150 can be configured for use with individuals having high levels of hand dexterity.

In some aspects, the user interface module 150 can comprise a joystick 152. Optionally, the joystick 152 can be a three-axis joystick. In exemplary aspects, translation movement of the wheelchair 10 can be effected by deflecting or otherwise manipulating the joystick 152, and rotation of the joystick can effect rotation of the wheelchair. In some aspects, the user interface module 150 can permit holonomic drive operation in translational and rotational motion.

The user interface module 150 can further comprise one or more buttons. For example, the user interface module 150 can comprise a first button 154 and a second button 156. The first and second buttons 154, 156 can be configured to raise and lower the seat.

In some aspects, the joystick 152 can be a two-axis joystick. The user interface module 150 can further comprise a plurality of buttons that permit selection of different modes of operation based on users' preferences. The two-axis joystick can provide a holonomic drive operation in translational and rotational motion. The first and second buttons let the user adjust the seat's vertical position. Two additional buttons (e.g., on the front of the joystick) can effect the rotational motion of the wheelchair in respective rotational directions. A switch and toggle button (e.g., on the left side of the user interface module) can be used to turn on the wheelchair and change modes of operation to use the joystick for translational or rotational motion, respectively. A second toggle button (e.g., on the right side of the user interface module) allows the user to control the seat's vertical position.

The controller can receive an input from the joystick 152 and buttons and any other input devices (e.g., switches, slides, touch screen, microphone, etc.). The controller can interpret the signals from the input devices and control the speed and direction of each of the motors 34 as well as the motor assembly 58. Control signals can be communicated to the motors via serial communication through a wired or wireless (e.g., Bluetooth) connection to operate each motor accordingly.

In further aspects, the user interface module 150 can comprise one or more of a charging port 160, a power switch button (not shown), a controller comprising a printed circuit board (PCB), or a wireless communication module (e.g., Bluetooth wireless communication).

Those skilled in the art will recognize, or be able to ascertain using no more than routine experimentation, many equivalents to the specific embodiments of the method and compositions described herein. Such equivalents are intended to be encompassed by the following claims.

What is claimed is:

1. A wheelchair comprising:
a base assembly including a body portion having a frame and a plurality of wheel assemblies secured to the body portion;
a seat assembly including a frame with a seating portion supported thereon; and
a vertical lift assembly that is secured to the base assembly and extends vertically upward therefrom,
wherein the vertical lift assembly is configured to move the seat assembly about and between a lowered vertical position and a raised vertical position, and wherein the lowered vertical position and the raised vertical position are separated by at least 24.0 inches.

2. The wheelchair of claim 1, wherein the lowered vertical position and the raised vertical position are separated by at least 36.0 inches.

3. The wheelchair of claim 1, wherein the vertical lift assembly comprises a linear actuator, the linear actuator comprising:
a lead screw that is operably secured to the base assembly and extends vertically upwardly therefrom; and
a cam assembly that is secured to the seat assembly, wherein the cam assembly is configured to travel linearly along the lead screw as the lead screw is rotated.

4. The wheelchair of claim 3, wherein the vertical lift assembly further comprises a pair of linear slide rail bearings extending upwardly from the base assembly on opposing sides of the lead screw, each linear slide rail bearing including an elongated rail and at least one bearing block that is secured to the frame of the seat assembly and is slidably secured to the elongated rail.

5. The wheelchair of claim 3, wherein the cam assembly of the linear actuator comprises one of a ball screw nut, a nut, or a toothed gear that is operably secured to both the seat assembly and the lead screw, and is configured to move linearly along the lead screw in a first direction when the lead screw is rotated in a clockwise direction and in an opposite second direction when the lead screw is rotated in a counter-clockwise direction.

6. The wheelchair of claim 5, further comprising a motor assembly secured to the base assembly and configured to selectively rotate the lead screw.

7. The wheelchair of claim 1, wherein each wheel assembly of the plurality of wheel assemblies has a respective axis of rotation, wherein the plurality of wheel assemblies includes a pair of front wheel assemblies and a rear wheel assembly, wherein the axis of rotation of a first front wheel assembly of the pair of front wheel assemblies forms an angle with the axis of rotation of a second front wheel assembly of the pair of front wheel assemblies, and wherein said angle is less than 180°.

8. The wheelchair of claim 7, wherein each front wheel assembly of the pair of front wheel assemblies further comprises a wheel having a hub assembly and a plurality of rollers, wherein each roller is disposed about an outer perimeter of the wheel and includes an axis of rotation that is transverse to the axis of rotation of the front wheel assembly.

9. The wheelchair of claim 7, wherein the rear wheel assembly has an axis of rotation that lies in a plane that is a plane of symmetry of the seating portion.

10. The wheelchair of claim 1, wherein the wheelchair is configured to move horizontally from a first horizontal position to a second horizontal position when the seating portion is in either the lowered vertical position and the raised vertical position.

11. A wheelchair comprising:
a base assembly including a body portion having a frame and a plurality of wheel assemblies secured to the body portion;
a seat assembly including a frame with a seating portion supported thereon; and
a vertical lift assembly including a linear actuator having a lead screw operably secured to the base assembly and extending vertically upwardly therefrom, and a cam assembly that is secured to the seat assembly and travels linearly along the lead screw as the lead screw is rotated,
wherein the seat assembly is movable about and between a lowered vertical position and a raised vertical position.

12. The wheelchair of claim 11, wherein the lowered vertical position and the raised vertical position are separated by at least 24.0 inches.

13. The wheelchair of claim 12, wherein the lowered vertical position and the raised vertical position are separated by at least 36.0 inches.

14. The wheelchair of claim 12, wherein the vertical lift assembly further comprises a pair of linear slide rail bearings extending upwardly from the base assembly on opposing sides of the lead screw, each linear slide rail bearing including an elongated rail and at least one bearing block that is secured to the frame portion of the seat assembly and is slidably secured to the elongated rail.

15. The wheelchair of claim 12, wherein the cam assembly of the linear actuator comprises one of a ball screw nut, a nut, or a toothed gear that is operably secured to both the seat assembly and the lead screw, and is configured to move linearly along the lead screw in a first direction when the lead screw is rotated in a clockwise direction and in an opposite second direction when the lead screw is rotated in a counter-clockwise direction opposite the clockwise direction.

16. The wheelchair of claim 15, further comprising a motor assembly secured to the base assembly and configured to selectively rotate the lead screw.

17. The wheelchair of claim 12, wherein the plurality of wheel assemblies includes a pair of front wheel assemblies and a rear wheel assembly, wherein an axis of rotation of a first front wheel assembly of the pair of front wheel assemblies forms an angle with an axis of rotation of a second front wheel assembly of the pair of front wheel assemblies, and wherein said angle is less than 180°.

18. The wheelchair of claim 17, wherein each front wheel assembly of the pair of front wheel assemblies further comprises a wheel having a hub assembly and a plurality of rollers, wherein each roller of the plurality of rollers is disposed about an outer perimeter of the wheel and includes an axis of rotation that is transverse to the axis of rotation of the front wheel assembly.

19. The wheelchair of claim 18, wherein each wheel assembly of the plurality of wheel assemblies further comprises an electric motor.

20. The wheelchair of claim 19, further comprising at least one battery removably secured to the base assembly, wherein the at least one battery is operably connected to the electric motors of the plurality of wheel assemblies and the motor assembly.
